(19) United States
(12) Patent Application Publication
(10) Pub. No.: US 2015/0161891 A1
(43) Pub. Date: Jun. 11, 2015

(54) IMPUTING PRICING CRITERIA FOR PARKING USING A COMBINATION OF PAYMENT DATA AND INCOMPLETE SENSOR DATA

(71) Applicant: Xerox Corporation, Norwalk, CT (US)

(72) Inventors: Christopher R. Dance, Grenoble (FR); Stephane Clinchant, Grenoble (FR); Onno R. Zoeter, Grenoble (FR)

(73) Assignee: Xerox Corporation, Norwalk, CT (US)

(21) Appl. No.: 14/223,187

(22) Filed: Mar. 24, 2014

Related U.S. Application Data
(60) Provisional application No. 61/913,554, filed on Dec. 9, 2013.

(51) Int. Cl. G08G 1/14; G06Q 10/06

(52) U.S. Cl. CPC G08G 1/141; G06Q 10/063

(57) ABSTRACT

A method for estimating average occupancy of a set of stalls based on incomplete occupancy data includes acquiring payment data for the set of stalls for each of a set of times and acquiring occupancy data for the set of stalls for each of the set of times, the occupancy data being acquired from a reporting subset consisting of fewer than all of the stalls. An estimate of a time integral of a function of occupancy is computed, based on the payment data and occupancy data and information is output based on the estimate.

This application claims the priority of U.S. Provisional Application Ser. No. 61/913,554, filed Dec. 9, 2013, entitled IMPUTING PRICING CRITERIA FOR PARKING USING A COMBINATION OF PAYMENT DATA AND INCOMPLETE SENSOR DATA, the disclosure of which is incorporated herein by reference in its entirety.

### BACKGROUND

The exemplary embodiment relates to a system and method for estimating occupancy, based on incomplete occupancy data. It finds particular application in connection with a system for modeling pricing criteria, such as for establishing parking prices, and will be described with particular reference thereto. However, it is to be appreciated that the system and method are applicable to similar prediction problems.

The availability of parking spaces may be insufficient or barely sufficient to meet the demand of drivers, particularly during peak times. To provide an evaluation of the availability and location of parking spaces, parking zone management systems have been developed which include a vehicle sensor for each parking space in a parking zone. The vehicle sensors each determine the occupancy status of the respective parking space, i.e., whether or not the space is free or is occupied by a vehicle. The occupancy data is communicated to a centralized system, allowing occupancy information to be made available, for example, to evaluate pricing arrangements, inform potential users of the parking zone that there are parking spaces available, or to provide information about a set of neighboring parking zones.

Parking providers, such as cities and private parking management companies, would like to be able to provide sufficient available spaces at prices which drivers are willing to pay. However, there are problems associated with acquiring information about occupancy. For example, the vehicle sensors are prone to failure. When a sensor fails, it no longer reports the occupancy state (occupied or available) of its respective parking space. Thus, the number of available parking spaces in a parking zone is not accurately reported to the centralized system when on or more of the sensors fails. Another problem is that it is costly to associate each parking space with its own sensor.

There remains a need for a system and method for estimating occupancy, e.g., of a set of parking spaces, without having access to occupancy data for all of the spaces.

### INCORPORATION BY REFERENCE

The following references, the disclosures of which are incorporated herein by reference in their entirety, are mentioned:

U.S. Pat. No. 4,971,505, issued Nov. 20, 1990, entitled ARCHITECTURAL STRUCTURE FOR OCCUPANCY AND PARKING, by Sawyer; U.S. Pat. No. 5,432,508, issued Jul. 11, 1995, entitled TECHNIQUE FOR FACILITATING AND MONITORING VEHICLE PARKING, by Jackson; U.S. Pat. No. 6,285,297, issued Sep. 4, 2001, entitled DETERMINING THE AVAILABILITY OF PARKING SPACES, by Ball; U.S. Pat. No. 6,344,806, issued Feb. 5, 2002, entitled PARKING STATUS CONTROL SYSTEM AND METHOD, by Katz; U.S. Pat. No. 6,671,737, issued Dec. 30, 2003, entitled DECENTRALIZED NETWORK SYSTEM, by Snowdon, et al.; U.S. Pat. No. 7,116,246, issued Oct. 3, 2006, entitled APPARATUS AND METHOD FOR SENSING THE OCCUPANCY STATUS OF PARKING SPACES IN A PARKING LOT, by Winter, et al.; U.S. Pat. No. 7,492,283, issued Feb. 17, 2009, entitled SYSTEMS AND METHODS FOR COMMUNICATION OF PARKING INFORMATION, by Racunas, Jr.; U.S. Pat. No. 7,647,185, issued Jan. 12, 2010, entitled APPARATUS AND METHOD FOR SENSING THE OCCUPANCY STATUS OF PARKING SPACES IN A PARKING LOT, by Tarassenko, et al.; U.S. Pat. No. 7,889,099, issued Feb. 15, 2011, entitled PARKING-ZONE MANAGEMENT SYSTEM, by Aubrey, et al.; U.S. Pub. No. 20130262059, published Oct. 3, 2013, entitled MODEL FOR USE OF DATA STREAMS OF OCCUPANCY THAT ARE SUSCEPTIBLE TO MISSING DATA, by Mihajlo Grbovic, et al.; U.S. Pub. No. 20130265419, published Oct. 10, 2013, entitled SYSTEM AND METHOD FOR AVAILABLE PARKING SPACE ESTIMATION FOR MULTISPACE ON-STREET PARKING, by Bulan, et al.; U.S. Pub. No. 20130265423, published Oct. 10, 2013, entitled VIDEO-BASED DETECTOR AND NOTIFIER FOR SHORT-TERM PARKING VIOLATION ENFORCEMENT, by Bernal, et al.; U.S. Pub. No. 20130266185, published Oct. 10, 2013, entitled VIDEO-BASED SYSTEM AND METHOD FOR DETECTING EXCLUSION ZONE INFRACTIONS, by Bulan, et al.; U.S. Pub. No. 20130266190, published Oct. 10, 2013, entitled SYSTEM AND METHOD FOR STREET-PARKING-VEHICLE IDENTIFICATION THROUGH LICENSE PLATE CAPTURING, by Wang, et al.; U.S. application Ser. No. 13/684,817, filed Nov. 26, 2012, entitled SYSTEM AND METHOD FOR ESTIMATION OF AVAILABLE PARKING SPACE THROUGH INTERSECTION TRAFFIC COUNTING, by Rong, et al.; U.S. application Ser. No. 13/835,386, filed Mar. 15, 2013, entitled TWO-DIMENSIONAL AND THREE-DIMENSIONAL SLIDING WINDOW-BASED METHODS AND SYSTEMS FOR DETECTING VEHICLES, by Bulan, et al.; U.S. application Ser. No. 13/836,310, filed Mar. 15, 2013, entitled METHODS AND SYSTEMS FOR AUTOMATED IN-FIELD HIERARCHICAL TRAINING OF A VEHICLE DETECTION SYSTEM, by Wu et al.; U.S. application Ser. No. 13/861,553, filed Apr. 12, 2013, entitled A WIRELESS PARKING REGISTER/PAYMENT AND VIOLATION NOTIFICATION METHOD AND SYSTEM, by Bulan, et al.; and U.S. application Ser. No. 13/898,883, filed May 21, 2013, entitled ROUTE COMPUTATION FOR NAVIGATION SYSTEM USING DATA EXCHANGED WITH TICKET VENDING MACHINES, by Denys Proux.

### BRIEF DESCRIPTION

In accordance with one aspect of the exemplary embodiment, a method for inferring occupancy information for a set of stalls based on incomplete occupancy data includes for each of a series of times, acquiring payment data and occupancy data for the set of stalls. The set of stalls include a reporting subset of the stalls which report occupancy and a non-reporting subset of stalls which do not report occupancy. The occupancy data is acquired from the reporting subset. An estimate of a time integral of a function of occupancy is computed over the time series, based on the payment data and occupancy data, and information based on the estimate is output.

One or more steps of the method may be performed with a computer processor.

In accordance with another aspect of the exemplary embodiment, a system for estimating average occupancy of a set of stalls based on incomplete occupancy data is provided. The system includes memory which stores, for each of a set of times, payment data received for a set of stalls and occupancy data received for the set of stalls. The set of stalls includes a reporting subset of the stalls which report occupancy and a non-reporting subset of stalls which do not report occupancy. The occupancy data is acquired from the reporting subset. Instructions are provided for computing an estimate of a time integral of a function of occupancy based on the payment data and occupancy data for each of the set of times. A processor in communication with the memory executes the instructions.

In accordance with another aspect of the exemplary embodiment, a method is provided for inferring occupancy information for a set of parking spaces based on incomplete occupancy data. The method includes, for each of a set of times in a series of times, acquiring payment data for each parking space in a set of parking spaces, and acquiring occupancy data from only a subset of the parking spaces which include occupancy sensors, the set of parking spaces including a subset of parking spaces which do not include occupancy sensors. With a processor, an estimate of occupancy of the set of parking spaces is computed over the series of times based on the payment data and occupancy data for each of the set of times and information based on the estimate is output.

### BRIEF DESCRIPTION OF THE DRAWINGS

FIG. 1 is a functional block diagram of an environment in which an exemplary occupancy prediction system operates in accordance with one aspect of the exemplary embodiment; and

FIG. 2 is a flowchart which illustrates a method for generating an occupancy prediction.

### DETAILED DESCRIPTION

A system and method combines occupancy time series data from sensors installed in a fraction of available parking spaces and payment time series data relating to both spaces-with-sensors and spaces-without-sensors to estimate a measure of occupancy, such as average occupancy of a set of parking spaces. The result is a statistic that can be used for policy making (e.g., a pricing criterion) or to assess the performance of a parking infrastructure. While the method is described with particular reference to parking spaces, it is to be appreciated that the method is applicable to other occupancy evaluations where the desired statistic is a time integral of a function of occupancy.

Above-mentioned U.S. Pub. No. 20130262059 describes methods for imputing the distribution of parking occupancy given missing sensor data at a specific time instant. In the present method, a time integral of a function of occupancy is imputed, rather than a distribution at a specific time instant. Additionally, both payment data and sensor data are used in the computation.

One advantage is that costly installation and maintenance of sensors in every space is can be avoided. The system and method enable accurate decision-making using a limited number of sensors, making sensor-based demand management economically viable to many more cities.

The exemplary system can be implemented in a relatively simple manner, that it is easy to understand, transfer and deploy. In one embodiment, no attempt is made to exploit spatial dependence beyond a single policy unit, such as an individual block face, although this is not excluded. Additionally, while temporal dependence can be limited to a specific hour of the day, other time frames are also contemplated.

The method aims to solve the following problem: given an occupancy time series from sensors installed in a fraction of stalls (parking spaces) of a set of stalls forming a policy unit, and a time series of payment data for the policy unit, estimate an integral of a given function of the full occupancy time series.

A “policy unit,” as used herein is any set of stalls, e.g., a set of two or more parking spaces, for which policy decisions are to be made, which can be occupied or unoccupied at a given time, such as a set of nearby parking spaces. For example, the policy unit can be a block face, which is the portion of one side of a street which lies between two other streets, a set of parking spaces for which tickets can be purchased at a common ticket machine, a parking garage, or the like. In general, the stalls forming a policy unit are adjoining or at least sufficiently close that a driver seeking to park a vehicle is able to select from the stalls that are unoccupied.

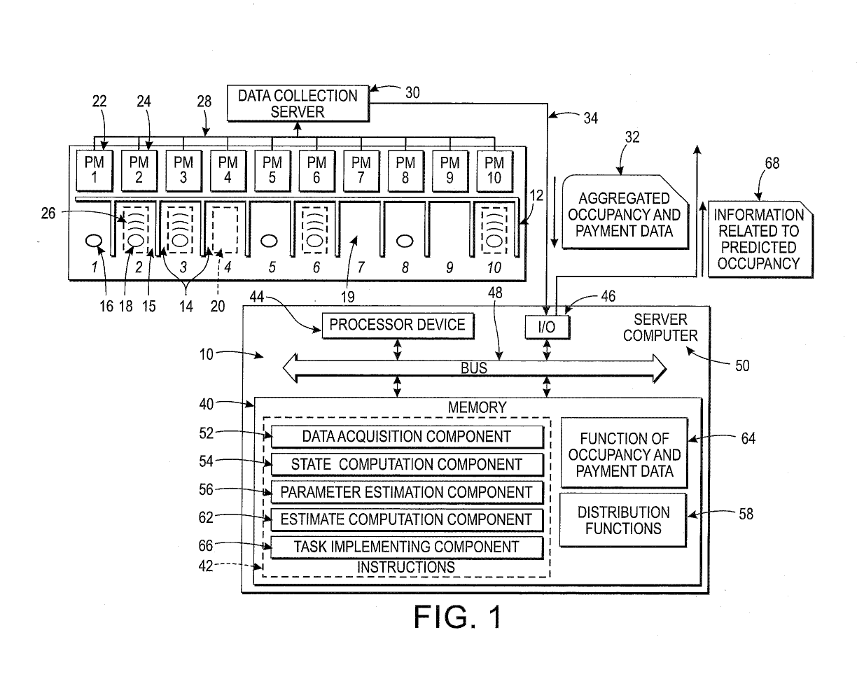

FIG. 1 illustrates an exemplary environment in which a system 10 for estimating occupancy for a set of stalls operates.

With reference to FIG. 1, an example environment in which an exemplary occupancy prediction system 10 operates is shown. A policy unit 12 includes a finite set of stalls 14, such as at least two, five, ten, or twenty stalls, at least some 15 of which include a respective operational occupancy sensor 16, 18, etc. and some 19, etc., do not (here, stalls numbered 1-3, 5-6, 8, and 10 have sensors and stalls 4, 7, and 9 do not). Some of the stalls 14 are occupied by objects 20. In the exemplary embodiment, the policy unit 12 is a parking zone, such as a blockface and the stalls 14 represent parking spaces, each of which is sized to receive a single vehicle 20, such as an automobile. The parking spaces may be delimited, for example with barriers, lines on the floor, or the like. As an example, the parking zone 12 may be a blockface used for on-street parking. In other embodiments, the parking zone 12 may include an indoor parking garage or a portion thereof. Any suitable vehicle sensor 16, 18 may be employed, such as a magnetometer, pressure sensor, visual sensor, or the like. Each sensor outputs sensor data which allows assigning the respective stall to only one of two states: occupied and unoccupied.

One or more payment devices such as parking meters 22, 24, and/or parking pass readers, is/are associated with the parking spaces 14. Drivers generally purchase a right to park for a certain time in one of the parking spaces in the block face 12 using the parking meter, although the vehicle may not occupy the stall for the full amount of the time, or in some cases may stay longer than the time paid for. In some instances, vehicles may be parked without any payment having been made.

The illustrated parking meters 22, 24 are single-space parking meters (one parking meter per parking space). However, multi-space parking meters are also contemplated in which one parking meter is associated with two or more parking spaces. The driver may designate a particular parking space when making payment or may be free to park in any unoccupied space. The parking meters generate payment data which indicates, for a given time period, whether a designated parking space (or an unspecified one of the set of parking spaces) has been paid for or not. Where the parking meter does not associate the payment information with a particular one of the stalls, the information as to whether the vehicle parked in a sensor stall or a stall missing a sensor can be deduced from whether one of the sensors registered the presence of a vehicle at about the payment time. If so, it is assumed that the vehicle associated with that payment was parked in a stall-with-sensor. The parking meters continue to register that a stall has been paid for while the payment is valid and/or until a detected event is occurred, such as that the parking space becomes unoccupied (in the case of parking spaces with sensors), when the parking meter may be reset to zero time. The output of the parking meters may be an event stream which includes the time at which payment was made, an ID of the policy unit and optionally also of the parking space, and the time when the meter will be expired.

The occupancy sensors 16, 18 output occupancy data indicating whether the respective parking space is occupied or not. For example, when a parking space 14 is occupied, the respective sensor 18 detects that a vehicle is present and sends a signal, such as a wireless signal 26, to the respective parking meter 24 or to a separate occupancy data collection device indicating the time at which the stall became occupied and an identifier of the stall. The sensor also sends similar information when the parking space is vacated. This reduces the amount of data which needs to be collected. Thus, at a given time instant t, the occupancy is that of the latest recorded event. In other embodiments, the sensors output information as to their occupancy status at regular time intervals, such as every minute.

The parking meters 22, 24 and sensors 16, 18 send the payment data and the occupancy data via a wired or wireless link 28 to a data collection server 30 from which a set of counts (described below) can be computed for each of a set of times t. The data collection server 30 aggregates the occupancy and payment information 32 and relays it to the system 10, via a wired or wireless link 34, such as the Internet.

Each of the parking spaces 14 is assumed to have only one of two occupancy states at any one time: occupied or non-occupied. In the illustrated policy unit 12, there are seven reporting vehicle sensors 16, 18 and three parking spaces which are missing a sensor. Thus, there is no reporting on the occupancy state for these stalls. The number/proportion of missing sensors can be selected based on various factors, which include the degree to which the payment information is a good indicator for their occupancy, and the degree to which the sensor stalls are good predictors of behavior in those without sensors. To improve this likelihood, the missing sensors may be distributed fairly evenly across the block face. For example, if 25% of the stalls are missing a sensor, the missing sensor stalls are approximately every fourth stall, rather than grouped together at one end of the block face. In one embodiment, at least 10%, or at least 20%, or at least 30%, or at least 40% of the stalls on a blockface are missing a sensor, such as up to 70% or up to 60% or about 50% of the stalls. For example, a ratio of non-reporting stalls to the total number of stalls in the set of stalls is at least 1:5. The exemplary method allows for this percentage to be tailored to the blockface, if it becomes evident that some blockfaces need more sensors in order for the computed estimate of the time average of the function of occupancy to be reliable. In some embodiments, it is found that 40-60% of stall with sensors can be effective. In some embodiments, the system can learn an appropriate number of sensors per blockface to provide reliable data (e.g., based on the average proportion of stalls with sensors where payments are made).

In the exemplary embodiment, the estimate of the time average of a function of occupancy of a blockface 12 is estimated using data acquired from the occupancy sensors 16, 18, and payment data from the parking meters. As will be appreciated, while only a single blockface 12 is illustrated, a set of such policy units 12 may exist in the exemplary operating environment, such as at least 2, or at least 10 policy units and in some embodiments, up to 100, or up to 1000 or more policy units. The policy units may vary in the number of stalls 14 that they each contain. For example, each of the policy units 12 may have at least 2 stalls, and at least some of the policy units each have at least 5 or at least 10 stalls, and in some embodiments, up to 100 or 100 stalls. For each blockface, a respective estimate may be computed and in some cases, aggregated over several blockfaces.

As will be appreciated, the data 32 from the reporting sensors 16, 18 and parking meters 22, 24 can be acquired by the system 10 in any suitable manner, such as from a website, from a memory storage device, or any other manner in which data can be acquired. In the exemplary embodiment, the aggregated data includes, for each policy unit, the number of sensor-stalls which are occupied and which have/have not been paid for, as well as the number of stalls which lack a sensor, for which a payment has/has not been made, for each of a plurality of time instances spaced throughout an extended time period, such as a day/week, e.g., over the course of several days/weeks.

The system 10 includes memory 40 which stores instructions 42 for performing the exemplary method and a processor 44, in communication with the memory for executing the instructions. A network interface 46 allows the system to communicate with external devices, such as the data collection server. Hardware components 40, 44, 46 are communicatively connected by a data/control bus 48. The system 10 may be hosted by one or more computing devices, such as the illustrated server computer 50.

The illustrated instructions include a data acquisition component 52, which acquires payment and occupancy data for the policy unit 12. A state computation component 54 computes the proportion of time that the policy unit 12 is in each of a set of states drawn from all the possible combinations of the observed states. A parameter estimation component 56 estimates parameters θ that are used to compute the probability of a total number of occupied stalls given the observed variables and a predefined set of distribution functions 60. An estimate computation component 62 computes an estimate of the time average function of occupancy 64. The value computed is an estimate \hat{Δ} of the average occupancy of the policy unit over a given period T. For example, it may be estimated that the blockface is 60% occupied during the time period T based on the input payment and occupancy data. Optionally, the computed value \hat{Δ} is output from the system.

This information \hat{Δ} may be used for a number of purposes, such as: setting pricing (the price for a subsequent given time period could be lowered if the occupancy is lower than a first threshold value and raised if above a second threshold value); evaluating whether there is a need for enforcement, e.g., if the payments received are relatively low in comparison with the revenue expected based on the estimated occupancy value; setting future policy, such as the need for additional parking spaces; and the like. A task implementing component 66 may perform a task which makes use of the computed value, such as computing parking prices for a set of blockfaces to maximize predicted revenue.

The system 10 may report, as output information 68, the estimate \hat{Δ} of the average number/proportion of occupied parking spaces over the given period T, or information based thereon, such as a set of revised parking prices.

While the exemplary parking occupancy problem is a specific case, the problem can be more generally described as the problem of predicting the average of a function of the proportion of bits set to on. In some embodiments, this may include computing average occupancy, i.e., average proportion of bits in a set to be ON (e.g., the number of parking spaces which are considered to be occupied, on the average), where the measurements of the individual bits can be missing from some of the samples. In other embodiments, the method can be used to estimate functions such as “the fraction of time that the set of stalls is fully occupied”.

The computer-implemented system 10 may be embodied in a PC, such as a desktop, a laptop, palmtop computer, portable digital assistant (PDA), server computer, cellular telephone, tablet computer, pager, combination thereof, or other computing device capable of executing instructions for performing the exemplary method.

The memory 40 may represent any type of non-transitory computer readable medium such as random access memory (RAM), read only memory (ROM), magnetic disk or tape, optical disk, flash memory, or holographic memory. In one embodiment, the memory 40 comprises a combination of random access memory and read only memory. In some embodiments, the processor 44 and memory 40 may be combined in a single chip. The network interface 46 allows the computer to communicate with other devices via a computer network, such as a local area network (LAN) or wide area network (WAN), or the internet, and may comprise a modulator/demodulator (MODEM).

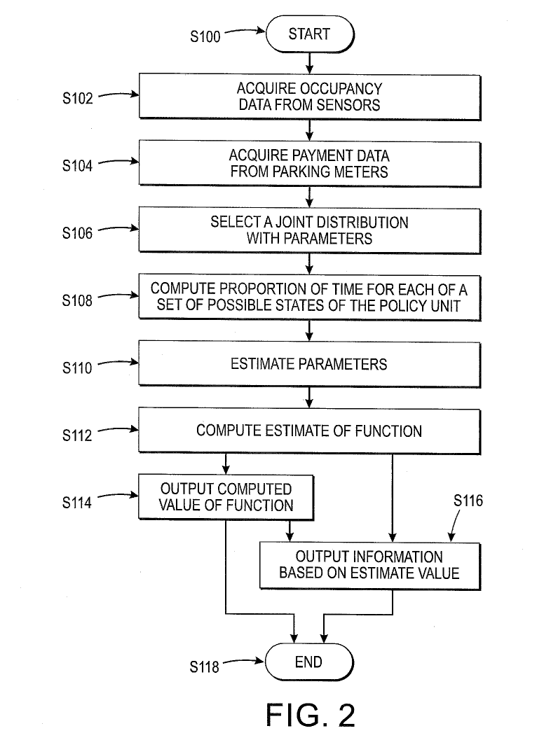

The digital processor 44 can be variously embodied, such as by a single-core processor, a dual-core processor (or more generally by a multiple-core processor), a digital processor and cooperating math coprocessor, a digital controller, or similar device. The exemplary digital processor 44, in addition to controlling the operation of the computer 50, executes instructions stored in memory 40 for performing the method outlined in FIG. 2.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

FIG. 2 illustrates an exemplary method for generating an estimate of average occupancy 30 and using the information in various applications, which can be performed in the environment of FIG. 1. The method begins at S100.

Occupancy and payment data 32 is acquired by the data acquisition component 52. For example, at S102, occupancy data is acquired from at least one policy unit 12, directly or indirectly. At S104, payment data is acquired for the same policy unit. Each item of data may include a timestamp indicating the time at which the data was acquired (such as the day and hour/minutes); and for each policy unit, a policy unit identifier, such as an alphanumeric code; the capacity (total number of stalls—alternatively, this could be obtained from a look up table); the number of stalls with sensors (alternatively, this could be obtained from a look up table); the number of stalls with sensors reporting occupied/unoccupied; the number of each type of stall for which payment is made/not made, and so forth. The data is stored in memory 40 during processing. The acquired data 32 may be processed to generate a set of observed variables for each of a set of discrete times t, as discussed below.

At S106, a joint distribution with parameters θ is defined. A function to be estimated may also be selected (this step may, of course, be performed earlier in the process).

At S108, for each state out of a predefined possible states, given the number of stalls and number of operational sensors, a proportion of the time that the policy unit spends in that state is estimated, based on the set of observed variables.

At 110 parameters θ are estimated.

At S112, an estimated value \hat{Δ} of the function is computed based on the parameters and observed variables.

At S114, the estimated value \hat{Δ} of the function may be output.

Optionally, at S116, a further task may be performed which uses the estimated value \hat{Δ} of one or more policy units, e.g. to set parking prices, as discussed above, and the information may be output.

The method ends at S118.

Further details of the system and method will now be described.

### DEFINITIONS

Some or all of the following counts at time t are used in the estimation: Zₛ^{op}(t), Zₛ^{o p̅}(t), Zₛ^{ōp}(t), Zₛ^{ō p̅}(t), Zₘ^{op}(t), Zₘ^{o p̅}(t), Zₘ^{ōp}(t), Zₘ^{ō p̅}(t), Z^{op}(t), Z^{o p̅}(t), Z^{ōp}(t), Z^{ō p̅}(t), Zₛ^{o}(t), Zₛ^{p}(t), Zₛ^{ō}(t), Zₛ ^{p̅}(t), Zₘ^{o}(t), Zₘ^{p}(t), Zₘ^{ō}(t), Zₘ ^{p̅}(t), Z^{o}(t), Z^{p}(t), Z^{ō}(t), Z ^{p̅}(t),

with the following interpretations:

Subscripts: s is for stalls with sensors (reporting stalls),
m (missing) is for stalls without a sensor (non-reporting stalls), and
no subscript means for all stalls, i.e., both s and m.

Superscripts: o is for an occupied stall,
ō is for a vacant stall,
p is for a paid stall, and
p̅ is for a not paid stall.

Counts: n is the total number of stalls in the policy unit,
nₛ is the number of stalls with sensors in the policy unit;
nₘ is the number of stalls without sensors in the policy unit, i.e., n=nₛ+nₘ

As examples of counts:
Zₘ^{o p̅}(t) is the number of stalls that are occupied but not paid for and that do not have a sensor, at time t;
Zₘ^{p}(t) is the number of stalls that are paid for and that do not have a sensor, at time t;
Zₛ^{op}(t) is the number of stalls that are occupied and paid for and that have a sensor, at time t;
Zₛ^{o p̅}(t) is the number of stalls that are occupied and not paid for and that have a sensor, at time t;
Zₛ^{ōp}(t) is the number of stalls that are unoccupied and paid for and that have a sensor, at time t;

Zₛ^{p}(t) is the number of stalls that are paid for and have a sensor, at time t, irrespective of whether or not they are occupied, so that Zₛ^{P}(t)=Zₛ^{op}(t)+Zₛ^{ōp}(t);
Z^{o}(t) is the number of stalls that are occupied, irrespective of whether or not they are paid for and irrespective of whether or not they have sensors, so that Z^{o}(t)=Zₛ^{o}(t)+Zₘ^{o}(t).

As will be appreciated, not all these counts are observable, specifically, when some of the sensors are “missing,” by which it is meant there is either no sensor for a given stall or the sensor that is there is not operational, so that there is no reporting for that stall. In the exemplary embodiment, fewer than all stalls in the policy unit have sensors, i.e., nₘ≧1, but at least some stalls have sensors, i.e., nₛ≧1, Thus, the occupancy Z^{o}(t) of the policy unit at time t is not known and thus can only be estimated.

The following notation is also used in the expressions below:

:=means is defined as.

[symbol] • [symbol] _{tεT} means the average of (what is in the bracket) over the set of times T.

A ̂ over a symbol indicates it is an estimate.

The indicator function 1_{A} for a statement A has the value 1 if statement A is true and 0 if statement A is false.

Given a time series of observable variables: Zₘ^{p}(t), Zₛ^{op}(t), Zₛ^{o p̅}(t), Zₛ^{ōp}(t) for each of a finite set of times tεT and a real-valued function of occupancy c(Z^{o}(t)), the aim is to estimate the time average integral:

$$Δ [ {Z}^{o} ( \cdot ) , T ] = {〈 c ( {Z}^{o} ( t ) ) 〉}_{t ∈ T} := \frac{{\int }_{T} c ( {Z}^{o} ( t ) ) d t}{{\int }_{T} d t} .$$

i.e., the function of the occupancy time series Z^{o} and the time interval T in question is an average of the real-valued function of occupancy c(Z^{o}(t)) over all times t in T.

The set of times T is typically a union of time intervals, such as Monday-to-Friday from 10 AM-11 AM for the last 8 weeks.

### Real Valued Function of Occupancy

In one example embodiment, the real-valued function of occupancy c(Z^{o}(t)) is a fraction-high-minus-fraction-low function c_{FHFL}(Z|n), which is defined as:

$${c}_{FHFL} ( Z \vert n ) := \{ \begin{matrix}- 1 , & Z = 0 \\ ( n - 1 ) {\int }_{\frac{Z - 1}{n - 1}}^{\frac{Z}{n - 1}} ( {1}_{x > h} - {1}_{x < l} ) d x , & 0 < Z < n \\ 1 , & Z = n\end{matrix}$$

where Z is an occupancy value which is an integer between 0 and n, n is the capacity of the block face, 1. is the indicator function (outputs 1 when the statement is true, 0 otherwise) and the parameters l and h are predefined low and high fractional occupancies, thus, 1 is lower than h. l and h may be, for example, l=0.7, h=0.9, although other values for l and h for are also contemplated such that (0<l<h<1), depending on the policy unit and the needs of the parking authority. This function sets c(Z^{o}(t)) at −1 when the blockface is empty, and at 1 when it is full, and gives a smoothed value for c(Z^{o}(t)) that is in between 0 and 1 when the occupancy of the blockface is between empty and full.

The fraction-high-minus-fraction-low function c_{FHFL}(Z|n) is simply the average [symbol] 1_{x>h}−1_{x<l} [symbol] _{xεI(Z)} of the fraction-high-minus-fraction-low indicator over the uniformly-spaced intervals

$$I ( Z ) := \frac{[ Z - 1 , Z ]}{n - 1} .$$

As will be appreciated, other functions of occupancy c(Z^{o}(t)) may be selected, For example, c(Z^{o}(t)) may be a function of the time that the policy unit has a predefined occupancy, such as 30% or 90% occupancy.

In another embodiment, the real valued function of occupancy c(Z^{o}(t)) may simply be an indicator function which outputs 1 if the policy unit is full, and 0 if empty. In another embodiment c(Z^{o}(t)) simply outputs a number of occupied stalls in the policy unit, i.e., c(Z^{o}(t))=Z^{o}(t).

In what follows, the method of generating the estimate will be described, and the independence approximation that it makes is discussed. Then specific distributional assumptions are described, with parameter estimation methods for those distributions.

The estimation method proceeds as follows:

Step 1. Select a Joint Probability Distribution with Parameters θ (S106)

Let the joint probability distribution for the desired, but only partially-observed occupancy Z^{o}(t) and for the set of observed variables: Y(t):=(Zₘ^{p}(t), Zₛ^{op}(t), Zₛ^{o p̅}(t), Zₛ^{ōp}(t)) (defined as described above), be of the form:

P(Z^{o}(t),Y(t)|θ)

i.e., the joint probability of the number of stalls Z^{o}(t) that are occupied at time t, and the observed variables Y(t) is dependent on a set of parameters θ.

Note that it is not necessary to explicitly include Zₛ^{ō p̅}(t) among these variables, since for a given number of observed stalls nₛ, Zₛ^{ō p̅}(t) can be determined from the other variables, since:

Zₛ^{op}(t)+Zₛ^{o p̅}(t)+Zₛ^{ōp}(t)+Zₛ^{ō p̅}(t)=nₛ.

However, the variable Zₛ^{ō p̅}(t) may of course be included.

Also, in the exemplary embodiment, it may be noted that the joint distribution can be expressed as P (Z^{o}(t),Y(t)|θ) rather than P (Z^{o}(t),Y(t)|θ,t), when working with time intervals that are short enough that stationarity is a good approximation.

In one simplified embodiment, it is assumed that Z^{o}(t) is independent of Zₛ^{op}(t),Zₛ^{o p̅}(t),Zₛ^{ōp}(t), given Zₛ^{o}(t) and θ, in which case, a joint distribution for P(Z^{o},Zₛ^{o},Zₘ^{p}|θ) can be employed, although Zₛ^{op}(t),Zₛ^{o p̅}(t),Zₛ^{ōp}(t) may still be useful for estimating parameters θ. Specific examples of methods for estimating the parameters are given below.

Step 2. Extract the Fraction of Time F(y) that the System Spends at Each State y from the Observations (S108)

The fraction F(y) for each state can be defined as:

$$F ( y ) := {〈 {1}_{Y ( t ) = y} 〉}_{t ∈ T} := \frac{{\int }_{T}^{ } {1}_{Y ( t ) = y} d t}{{\int }_{T}^{ } d t} .$$

This information can be computed by generating a data structure, such as a matrix. As an example, in the simple case where there are 2 stalls, one which has a sensor and one which does not, the possible states for each variable are Zₘ^{p}(t)=1,0; Zₛ^{op}(t)=1,0; Zₛ^{o p̅}(t)=1,0; Zₛ^{ōp}(t)=1,0; so 16 possible states in all. As the number of stalls increases, the number of possible states increases, so a sparse vector may be a more appropriate representation than a matrix.

Step 3. Calculate an Estimate \hat{θ} of Parameters θ (S110)

Various methods for estimating parameters θ are contemplated, as discussed below. The parameters predict Z^{o} using predefined distributions for predicting unobserved observations for non-reporting stalls, such as counts Zₘ^{op}, Zₘ^{ōp}, and hence Zₘ^{p}.

### Step 4. Make an Independence Approximation (See Below), Resulting in the Estimate of the Time Integral of a Function of Occupancy (S112)

The estimate of the time integral of a function of occupancy is defined as shown in Equation 1:

$${\hat{Δ} [ {Z}^{o} ( \cdot ) \vert Y ( \cdot ) , T ] := 〈 c ( {Z}^{o} ( t ) ) \vert ( Y ( t ) : t ∈ T ) , \hat{θ} 〉}_{t ∈ T} = {\sum }_{{Z}^{o} = 0}^{n} {\sum }_{Y ∈ 𝓎} c ( {Z}^{o} ) P ( {Z}^{o} \vert Y , \hat{θ} ) F ( Y ) \qquad ( 1 )$$

i.e., a sum over all possible values of Z^{o} and all possible values of Y(t), where the set of all possible values of Y(t) is [symbol] ,

c(Z^{o}) is the function of occupancy, computed for example as discussed above. For example, in the case where the fraction-high-minus-fraction-low function is used, when Z^{o}=0, c(Z^{o}) is −1, thus the value of c(Z^{o})P(Z^{o}|Y,\hat{θ})F(Y) will equal −P(Z^{o}|Y,\hat{θ})F(Y), and when Z^{o}=n the value c(Z^{o}) is 1, thus) c(Z^{o})P(Z^{o}|Y,\hat{θ})F(Y)=P(Z^{o}|Y,\hat{θ})F(Y), and so forth.

P(Z^{o}|Y,\hat{θ}) is the conditional probability of Z^{o} given the set of observations Y and the set of parameters θ (or more conveniently, an estimate of the parameters, denoted \hat{θ}), for all values of Z^{o}, all values of Y and all values θ, and is given by:

$$P ( {Z}^{o} \vert Y , θ ) = \frac{P ( {Z}^{o} , Y \vert θ )}{{\sum }_{{Z}^{o} = 0}^{n} P ( {Z}^{o} , Y \vert θ )} .$$

i.e., the conditional probability P(Z^{o}|Y,θ) is defined as a ratio of a joint probability of Z^{o} and observations Y, given θ, divided by a sum over all values of the occupancy Z^{o} from 0 to n of the joint probability P(Z^{o},Y|θ), given θ. The denominator ensures that all conditional probabilities sum to 1.

Independence Approximation

Eqn (1) is a valid inference under an independence assumption that:

P(Zₘ^{o}(t)=z|(Y(t):tεT),θ)=P(Zₘ^{o}(t)=z|Y(t),θ) (2)

which states that Zₘ^{o}(t) is conditionally independent of the observations Y(s) at other times, given Y(t) for s≠t, i.e., the variables for times s other than t do not impact the unobserved count Zₘ^{o}(t) of stalls with missing sensors which are occupied at time t. This approximation, although not strictly true, is simple and also works well in practice.

This assumption would be appropriate for a Hidden Markov Model (HMM) in which Y(t) is the hidden state and Zₘ^{o}(t) are the observations. However, here the converse is the case, i.e., Y(t) is observed and Zₘ^{o}(t) is hidden. A more complex model could involve treating the full state:

(Zₛ^{op}(t),Zₛ^{o p̅(t),Z}ₛ^{ōp}(t),Zₘ^{op}(t),Zₘ^{o p̅}(t),Zₘ^{ōp}(t))

as a Markov chain with exponential transition times and applying a forwards-backwards algorithm. However, the inter-arrival times and durations of parking processes are often not well modeled by exponential distributions. Thus the more complex HMM may perform worse, in practice, than simple marginal models, of the type described below.

Thus, for example, it can be assumed that if the observed count Zₛ^{o}(t) of stalls with sensors that are occupied increases, then the unobserved count Zₘ^{o}(t) of stalls without sensors that are occupied also increases proportionately.

Validity of the Independence Approximation

The following demonstrates the validity of the Independence Approximation given in Eqn (2): Applying linearity of expectation to the integral in the time average [symbol] c(Z^{o}(t))|(Y(t):tεT),\hat{θ} [symbol] _{tεT} gives:

$$E [ {\int }_{T}^{ } c ( {Z}^{o} ( t ) ) \vert ( Y ( t ) : t ∈ T ) , \hat{θ} ] = {\sum }_{z = 0}^{n} c ( z ) E [ {\int }_{T}^{ } {1}_{{Z}^{o} ( t ) = z} d t \vert ( Y ( t ) : t ∈ T ) , \hat{θ } ]$$

in which Fubini's theorem and the fact that E 1_{X}=P (X) gives:

$$E [ {\int }_{T}^{ } {1}_{{Z}^{o} ( t ) = z} d t \vert ( Y ( t ) : t ∈ T ) , \hat{θ } ] = {\sum }_{y ∈ 𝓎} {\int }_{T}^{ } {1}_{Y ( t ) = y} P ( {Z}_{m}^{o} ( t ) = z - {Z}_{o}^{o} ( y ) \vert ( Y ( t ) : t ∈ T ) , \hat{θ} ) d t$$

where Zₛ^{o}(y) denotes the value of Zₛ^{o}(t) is Y(t)=y. Under the independence approximation and noting the stationarity assumed in Step 1, then:

$${\int }_{T}^{ } {1}_{Y ( t ) = y} P ( {Z}_{m}^{o} ( t ) = z - {Z}_{s}^{o} ( y ) \vert ( Y ( t ) : t ∈ T ) , \hat{θ} ) d t = P ( {Z}^{o} ( t ) = z \vert Y ( t ) , θ ) {\int }_{T}^{ } {1}_{Y ( t ) = y} d t .$$

Finally, applying the definition of F(y) to ∫_{T}1_{Y(t)=y}dt and combining the above steps gives the estimate stated in Equation 1.

### Specific Distributional Assumptions

Various parameters θ are contemplated. In the simplified case mentioned in Step S106 of the method, the joint distribution can be written as:

P(Z^{o},Zₛ^{o},Zₘ^{p}|θ)=P(Z^{o}|θ)P(Zₛ^{o}|Z^{o},θ)P(Zₘ^{p}|Z^{o},Zₛ^{o},θ) (4)

This means that the joint probability of the number of stalls that are occupied Z^{o}, the number of stalls with a sensor that are occupied Zₛ^{o}, and the number of stalls without a sensor that are occupied Zₘ^{p}, given the parameters θ, is a product of three probabilities, each of which can be assumed to follow a probability distribution. Example probability distributions include binomial, (truncated) beta-binomial, and hypergeometric distributions, although other distributions are contemplated. As examples, for the individual factors on the right-hand side of the equation, the following choices work well in practice, but other alternative distributions could be employed:

Z^{o}|θ˜beta-binomial(n,θ^{α},θ^{β}) (5)

Zₛ^{o}|Z^{o}˜hypergeometric (6)

Zₘ^{op}|Zₘ^{o},θ˜binomial(Zₘ^{o},θ^{p|o}) (7)

Zₘ^{ōp}|Zₘ^{ō},θ˜binomial(Zₘ^{ō},θ^{p|ō}) (8)

where:
Zₘ^{op}+Zₘ^{ōp}=Zₘ^{p},
Zₛ^{o}+Zₘ^{o}=Z^{o},
Zₘ^{o}+Zₘ^{ō}=nₘ, so that

$$P ( {Z}_{m}^{p} \vert {Z}^{o} , {Z}_{s}^{o} , θ ) = {\sum }_{{Z}_{m}^{op} = 0}^{{n}_{m}} P ( {Z}_{m}^{op} \vert {Z}_{m}^{o} = {Z}^{o} - {Z}_{s}^{o} , θ ) P ( {Z}_{m}^{\overline{o} p} \vert {Z}_{m}^{\overline{o}} = {n}_{m} - {Z}^{o} + {Z}_{s}^{o} , θ ) .$$

In this embodiment, four parameters are considered:

The parameters θ^{α}, θ^{β} of are the variable parameters of a beta-binomial distribution.

The parameter θ^{p|o} represents under the assumption of binomial distribution, the probability that it is paid given that it is occupied.

The parameter θ^{p|ō} represents, under the assumption of binomial distribution, the probability that it is paid given that it is unoccupied.

More generally, one or more of the following assumptions is made:

1. Stalls-with-sensors and stalls-without-sensors are allowed to have different marginal occupancy probabilities, for instance using Fisher's generalized hypergeometric distribution.

2. Some over-dispersion for the fraction of paid stalls is allowed, by setting:

Z^{p}|Z^{o},θ˜beta-binomial(Z^{o},θ^{a′},θ^{β}).

3. A different distribution for Z^{o}|θ may be used, such as a truncated McDonald generalized beta-binomial, a truncated Poisson distribution, or a discrete mixture model.

4. The estimation is treated as a general regression problem over a large class of models. A detailed model is fitted to each block face in a 100% initial deployment followed by a sparse continuation. Or the restriction can be made that the found model works well over all block faces in 100% training sets (where all stalls have sensors) and use the resulting model in new deployments that use a sparse sensor deployment from day 1.

The distributions used can be evaluated using existing data for cities which have sensors in all stalls to determine whether the estimates output by Eqn. 1 are reasonable. In practice, it is found that the distributions given in Eqns. 5-8 work well for data from different cities, and thus need not be modified when considering different sized parking networks or locations.

### Parameter Estimation

For simplicity, method-of-moments estimates θ_{MOM} can be used for parameter estimation. In one embodiment, it is assumed that stalls-with-sensors behave like stalls-without-sensors, on average. For example it is reasonable to assume that a stall with a sensor and a stall without a sensor have the same probability that they will be paid for (for example, because drivers are not aware that some stalls have sensors and others do not, or that drivers do not change their behavior based on whether a stall has a sensor or not).

For the beta-binomial distribution, discussed above, the relevant estimates are:

θ_{MOM}^{α}:=γp, θ_{MOM}^{β}:=γ−α,

where

$$p := {\sum }_{z = 0}^{{n}_{s}} \frac{{F}_{{Z}_{s}^{o}} ( z ) z}{{n}_{s}} ,$$

(i.e., p is the average occupancy fraction of the stalls with sensors)

and

$$γ := \frac{n - p}{ρ - 1} ,$$

where F_{Z}_{ₛ}_{^{o}}(z) is the fraction of time T for which the occupancy of the stalls-with-sensors is z and ρ is the over-dispersion parameter, which is a positive value (it has been found that ρ=1.4 works well).

Similarly, for the binomials the following parameters can be used:

$${θ}_{MOM}^{p \vert o} = \frac{{\sum }_{z = 0}^{{n}_{s}} {zF}_{{Z}_{s}^{op}} ( z )}{{\sum }_{z = 0}^{{n}_{s}} {zF}_{{Z}_{s}^{o}} ( z )} , {θ}_{MOM}^{p \vert \overline{o}} = \frac{{\sum }_{z = 0}^{{n}_{s}} {zF}_{{Z}_{s}^{\overline{o} p}} ( z )}{{\sum }_{z = 0}^{{n}_{s}} {zF}_{{Z}_{s}^{\overline{o}}} ( z )}$$

where F_{Z}_{ₛ}_{^{op}}(z) is the fraction of time for which the number of stalls-with-sensors that are simultaneously paid and occupied is z, F_{Z}_{ₛ}_{^{ōp}}(z) is the fraction of time for which the number of stalls-with-sensors that are simultaneously paid and vacant is z and F_{Z}_{ₛ}_{^{ō}}(z) is the fraction of the time for which z of the stalls-with-sensors are vacant,

θ_{MOM}^{p|o} is thus the average number of occupied, paid, reporting stalls, divided by the average number of occupied, reporting stalls, and θ_{MOM}^{p|ō} is the average number of unoccupied, paid, reporting stalls, divided by the average number of unoccupied, reporting stalls.

These values can be plugged into Eqns 5-8.

It is also contemplated that the parameters may be estimated by maximum Likelihood Estimation (MLE) or by empirical risk minimization. Another alternative is to estimate a belief about θ and integrate out the parameter in Equation (1).

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the exemplary method.

The information generated has a variety of uses including

1. Policy changes-such as setting prices, time limits and so forth.

2. Enforcement-guiding enforcement to places where estimated occupancy is high relative to payments.

3. Guidance-guiding drivers to parking zones where it is estimated that there will be empty spaces.

4. Policy evaluation-reviewing the effects of policy changes on parking behavior.

Without intending to limit the scope of the exemplary embodiment, the following Example demonstrates application of the exemplary method.

### Example

An experiment was conducted with data from a parking pilot program for a US city. All block faces with IPS parking meters were used. The time series for each hour of Monday-to-Friday 9 AM-4 PM for all 8 week periods from January 2013 to June 2013 and for a range of fractions-of-installed-sensors (i.e. coverage) were extracted. For each coverage, the sensors were selected so as to minimize the squared error in predicting average occupancy based on kriging. Kriging (or Gaussian process regression) is a method of interpolation for which the interpolated values are modeled as a Gaussian process with given covariances). The kriging method is not described in detail here since it was found that the performance gain is limited to only a 2% improvement in root-mean-squared errors (RMSEs).

Three methods were evaluated:

1. A “pseudo-capacity method” (C) which estimates:

Δ_{C}:= [symbol] c_{FHFL}(Zₛ^{o}(t)|nₛ) [symbol] _{tεT}

where c_{FHFL}(Z|n) is as defined above. This method acts as if there are nₛ stalls with occupancy Zₛ^{o} rather than n stalls with occupancy Z^{o}. (This method has been used when a few sensors go missing).

A baseline method (S) using only the sensor time series, which is obtained simply by dropping all information about Zₘ^{p} from the exemplary method.

The exemplary method (P) using payments and partial sensor information.

The root-mean-squared errors in estimating the fraction-high-minus-fraction low values are shown in TABLE 1:

TABLE 1

| | Method | | |
|---|---|---|---|
| Coverage (%) | C | S | P |
| 21 | 0.318 | 0.186 | 0.175 |
| 31 | 0.230 | 0.161 | 0.152 |
| 42 | 0.173 | 0.130 | 0.122 |
| 52 | 0.131 | 0.108 | 0.103 |
| 63 | 0.112 | 0.094 | 0.088 |
| 73 | 0.087 | 0.075 | 0.071 |
| 83 | 0.057 | 0.050 | 0.046 |

As can be seen from Table 1, a 10% increase in coverage results in a 15-35% reduction in RMSE for all methods. The RMSE for the pseudo-capacity method C is 40% larger than the RMSE for the exemplary method P, on average. The RMSE for the sensor-only method S is 6% larger than the RMSE for the exemplary method P on average. The present method thus provides a valuable improvement over existing methods.

The results suggest that payment information is beneficial and cities are expected to prefer a system that can exploit payment information. While the benefit was relatively small, this may be due in part to the fact that in many parts of the test region, fewer than 50% of occupancies correspond to payments. Since the system can be utilized to identify policy units which would benefit from higher levels of enforcement, this may help to improve the benefit. Second, even if payments are made, they do not correspond to the exact duration of stay, partly because people pay with coins that have discrete values and partly because people do not know how long they will stay. In other cities, the benefit is expected to be larger.

Finally, it is worth comparing the RMS errors with the period-to-period RMS variation in the full fraction-high-minus-fraction-low criterion Δ. This is because pricing systems used in this city study implicitly assume that the pricing criterion in the next period will be similar to that in the current period if no changes are made. Indeed, it is found that the RMS variation in Δ from period-to-period is about 0.15, which is approximately the same as the RMSE in the estimates for the exemplary method P, given 31% sensor coverage. This suggests that 50% sensor coverage may be used, with little additional error in policy decision making over the errors made by the existing systems.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for inferring occupancy information for a set of stalls based on incomplete occupancy data, the method comprising:
for each of a series of times:
acquiring payment data for a set of stalls; and
acquiring occupancy data for the set of stalls, the set of stalls including a reporting subset of the stalls which report occupancy and a non-reporting subset of stalls which do not report occupancy, the occupancy data being acquired from the reporting subset;
with a processor, computing an estimate of a time integral of a function of occupancy over the series of times based on the acquired payment data and occupancy data; and
outputting information based on the estimate.

2. The method of claim 1, wherein the stalls comprise parking spaces.

3. The method of claim 1, wherein the occupancy data includes a count of the stalls in the reporting subset that are occupied at each of the times in the set of times.

4. The method of claim 1, wherein the estimating of the time integral includes, for each of the times, computing a set of observations Y(t) based on the acquired payment data and occupancy data, the observations being selected from:
a first count Zₘ^{p}(t), of the non-reporting stalls that are paid for, at time t;
a second count Zₛ^{op}(t), of the reporting stalls that are occupied and paid for, at time t;
a third count Zₛ^{o p̅}(t), of the reporting stalls that are occupied and not paid for, at time t;
a fourth count Zₛ^{ōp}(t), of the reporting stalls that are unoccupied and paid for, at time t.

5. The method of claim 4, further comprising, extracting a fraction of time F(y) that the set of stalls spends at each state y in a set of states from the observations, each of the states in the set of states representing different values for each of the first, second, third, and fourth counts.

6. The method of claim 5, wherein the estimate of the time integral of the function of occupancy is computed as a function of:
$${\sum }_{{Z}^{o} = 0}^{n} {\sum }_{Y ∈ 𝓎} c ( {Z}^{o} ) P ( {Z}^{o} \vert Y , \hat{θ} ) F ( Y ) \qquad ( 1 )$$
for each time t in the set of times,
where Z^{o}(t) represents a count of the stalls which are occupied at time t,
c(Z^{o}(t)), is the real-valued function of occupancy; [symbol]
is a set of possible values of the set of observations Y(t),
n is the total number of stalls in the set of stalls, and
P(Z^{o}|Y,\hat{θ}) is a probability distribution function which estimates Z^{o}(t) given Y(t) and an estimated set of parameters B which predict observations for non-reporting stalls based on predefined distributions.

7. The method of claim 6, wherein the probability distribution function
$$P ( {Z}^{o} \vert Y , θ ) = \frac{P ( {Z}^{o} , Y \vert θ )}{{\sum }_{{Z}^{o} = 0}^{n} P ( {Z}^{o} , Y \vert θ )} .$$

8. The method of claim 6, wherein the predefined distributions are selected from beta-binomial, hypergeometric, and binomial distributions.

9. The method of claim 7, wherein the joint distribution P(Z^{o},Y|θ) is expressed as a joint distribution P(Z^{o},Zₛ^{o},Zₘ^{p}|θ)=P(Z^{o}|θ)P(Zₛ^{o}|Z^{o},θ)P(Zₘ^{p}|Z^{o},Zₛ^{o},θ),
where Zₘ^{p} is a count of non-reporting stalls for which payment has been made.

10. The method of claim 7, wherein the distributions include:
Z^{o}|θ is treated as a beta-binomial (n, θ^{α}, θ^{β}),
Zₛ^{o}|Z^{o} treated as a hypergeometric,
Zₘ^{op}|Zₘ^{o},θ is treated as a binomial (Zₘ^{o},θ^{p|o}), and
Zₘ^{ōp}|Zₘ^{ō},θ is treated as a binomial (Zₘ^{ō},θ^{p|ō}).

11. The method of claim 10, wherein for the beta-binomial, parameter estimates are:
θ_{MOM}^{α}:=γp, θ_{MOM}^{β}:=γ−α,
where
$$p := {\sum }_{z = 0}^{{n}_{s}} \frac{{F}_{{Z}_{s}^{o}} ( z ) z}{{n}_{s}} , γ := \frac{n - p}{ρ - 1} ,$$
and where F_{Z}_{ₛ}_{^{o}}(z) is the fraction of time T for which the occupancy of the reporting stalls is z and p is an over-dispersion parameter and wherein for the binomials the parameter estimates are:
$${θ}_{MOM}^{p \vert o} = \frac{{\sum }_{z = 0}^{{n}_{s}} {zF}_{{Z}_{o}^{op}} ( z )}{{\sum }_{z = 0}^{{n}_{os}} {zF}_{{Z}_{o}^{o}} ( z )} and {θ}_{MOM}^{p \vert \overline{o}} = \frac{{\sum }_{z = 0}^{{n}_{s}} {zF}_{{Z}_{s}^{\overline{o} p}} ( z )}{{\sum }_{z = 0}^{{n}_{s}} {zF}_{{Z}_{s}^{\overline{o}}} ( z )} .$$

12. The method of claim 6, wherein the real-valued function of occupancy c(Z^{o}(t)) is a fraction-high-minus-fraction-low function which is defined as:
$$= \{ \begin{matrix}- 1 , & Z = 0 \\ ( n - 1 ) {\int }_{\frac{Z - 1}{n - 1}}^{\frac{Z}{n - 1}} ( {1}_{x > h} - {1}_{x < l} ) d x , & 0 < Z < n \\ 1 , & Z = n\end{matrix}$$
where n is the capacity of the set of stalls,
1. is the indicator function,
Z is a value of the occupancy,
and parameters l and h are predefined low and high fractional occupancies.

13. The method of claim 1, wherein the outputting information comprises outputting the estimate.

14. The method of claim 1, wherein the method further comprises generating a pricing policy for the stalls based on the estimate and the outputting information comprises outputting the pricing policy.

15. The method of claim 1, wherein a ratio of non-reporting stalls to the total number of stalls in the set of stalls is at least 1:5.

16. The method of claim 1, further comprising computing the estimate of a time integral of a function of occupancy for each of a plurality of sets of stalls.

17. The method of claim 1, wherein the payment data comprises, for each stall in the set of stalls, whether a payment covering time t has been made.

18. A computer program product comprising a non-transitory computer-readable storage medium storing instructions, which when executed by a computer, perform the method of claim 1.

19. A system comprising memory which stores instructions for performing the method of claim 1 and a processor in communication with the memory for executing the instructions.

20. A system for estimating average occupancy of a set of stalls based on incomplete occupancy data, the system comprising:
memory which stores:
for each of a set of times:
payment data received for a set of stalls; and
occupancy data received for the set of stalls, the set of stalls including a reporting subset of the stalls which report occupancy and a non-reporting subset of stalls which do not report occupancy, the occupancy data being acquired from the reporting subset; and
instructions for computing an estimate of a time integral of a function of occupancy based on the payment data and occupancy data for each of the set of times; and
a processor in communication with the memory for executing the instructions.

21. A method for inferring occupancy information for a set of parking spaces based on incomplete occupancy data, the method comprising:
for each of a set of times in a series of times:
acquiring payment data for each parking space in a set of parking spaces; and
acquiring occupancy data from only a subset of parking spaces which include occupancy sensors, the set of parking spaces including a subset of parking spaces which do not include occupancy sensors;
with a processor, computing an estimate of occupancy of the set of parking spaces over the series of times based on the payment data and occupancy data for each of the set of times; and
outputting information based on the estimate.
